(19) United States
(12) Patent Application Publication
(10) Pub. No.: US 2013/0029194 A1
(43) Pub. Date: Jan. 31, 2013

(54) Module for an Electrical Charge Storage Apparatus Including a Seal Layer and a Method of Making the Same

(71) Applicant: Steven L. Peace, Whitefish, MT (US)

(72) Inventor: Steven L. Peace, Whitefish, MT (US)

(73) Assignee: ZINC AIR INCORPORATED, Columbia Falls, MT (US)

(21) Appl. No.: 13/192,834

(22) Filed: Jul. 28, 2011

(51) Int. Cl. H01M 2/40; H01M 8/18

(52) U.S. Cl. 429/70; 29/623.2

(57) ABSTRACT

A flow cell battery system includes a plurality of stacked cells that include an anode plate and a cathode plate that are separated by a seal layer off an inner side of the anode plates and cathode plates. An outer side of the anode plates and cathode plates is disposed in an anolyte flow path and a catholyte flow path, respectively. A membrane acts as a barrier between the anolyte flow path and the catholyte flow path. A flow screen may be provided in the flow paths to mix the anolyte and catholyte in the respective flow paths.

### TECHNICAL FIELD

The present disclosure relates to an electrical charge storage system, and a method of making a stacked battery using modular components including a seal layer between electrically connected pairs of oppositely charged plates.

### BACKGROUND

An electrical charge storage system includes one or more cells that store energy received from a source that charges the cell and releases the energy to a load by discharging the cell. Each cell has an anode and a cathode that an electrolyte flows across. Electrons in the electrolyte are transferred between the cathode and the anode to store energy in the system. The system is charged when current is applied to terminals causing electrons to flow from the cathode to the anode. Energy is discharged from the system when a load is applied to the terminals causing electrons to flow from the anode to the cathode.

Patents that were reviewed in conjunction with preparation of this disclosure include U.S. Pat. Nos. 4,892,632; 7,670,719; and U.S. Publication Nos. 2009/2330138A1; 2010/0086829A1; and 2010/215999A1. No representation is made that this is the only relevant art or that it is the most relevant art available to this disclosure.

### SUMMARY

According to one aspect of this development, a module is provided for an electrical charge storage apparatus that circulates an anolyte fluid and a catholyte fluid to charge and discharge the apparatus. The module includes an anode plate assembly including a first anode plate and a first separator membrane defining the anolyte fluid passage on an outer side of the anode plate. The module also includes a cathode plate assembly including a first cathode plate and a second separator membrane defining a catholyte fluid passage on an outer side of the cathode plate. At least one pole piece hub conductively connects an inner side of the anode plate assembly to an inner side of the cathode plate assembly. A seal layer is disposed between the anode plate and the cathode plate that defines an opening for each pole piece hub. The seal layer precludes the flow of the anolyte fluid and the catholyte fluid between the anode plate and the cathode plate.

According to another aspect of this development, an energy storage cell is provided that circulates an anolyte and a catholyte. The energy storage cell comprises a housing that defines a first set of flow passages for the anolyte and a second set of flow passages for the catholyte. A plurality of anode plates are provided that have an inner surface and an outer surface and a plurality of cathode plates are also provided that have an inner surface and an outer surface. A plurality of conductors are assembled between the inner surface of the anode plates and the inner surface of the cathode plates to electrically connect one of the anode plates to one of the cathode plates to form a paired anode plate and a cathode plate assembly. Each paired anode plate and cathode plate assembly is maintained at the same electrical potential. A plurality of separator membranes are disposed between the outer surface of one of the anode plates and the outer surface of one of the cathode plates that defines an anolyte fluid passage and a catholyte fluid passage on opposite sides of each of the separator membranes. A seal layer is provided between the inner surface of the anode plates and the inner surface of the cathode plates. The seal defines an opening for each of the conductors. The seal prevents the anolyte and the catholyte from flowing between the inner surfaces of the anode plates and the inner surfaces of the cathode plates.

According to other aspects of the energy storage module and energy storage cell as summarized above, a first flow screen may be disposed in the anolyte fluid passage and a second flow screen may be disposed in the catholyte fluid passage. Alternatively, a nickel foam member may be disposed in the catholyte fluid passage and the cathode plate assembly may be plated with a nickel plating.

The seal may include four openings with two pole piece hubs being provided on the anode plate and two pole piece hubs being provided on the cathode plate. The anode plate and pole piece hubs provided on the anode hub are structurally identical to the cathode plate and two pole piece hubs provided on the cathode plate. The anode plate and cathode plate are assembled to each other in an opposite orientation with the hubs spaced from each other.

A housing may be provided that receives the anode plate, the cathode plate and the seal. The housing defines anolyte inlet passages and anolyte outlet passages that are in fluid flow communication with the anolyte fluid passage. The housing also defines catholyte inlet passages and catholyte outlet passages that are in fluid flow communication with the catholyte fluid passage. A peripheral seal may be provided between the housing, and the anode plate, and the cathode plate that separates the anolyte from the catholyte.

According to another aspect of this development, a method is disclosed for making an energy storage cell. According to the method, a plurality of anode plates and cathode plates are selected that each have an inner side and an outer side. At least one conductor is attached between each of the inner sides of the anode plates and cathode plates. A plurality of seal layers each define at least one opening. Each of the seals is assembled between the inner side of one of the anode plates and the inner side of one of the cathode plates with the conductors each being received within one of the openings in the seals. A separator membrane is assembled between each of the spaced outer sides of the anode plates and the cathode plates to define a plurality of adjacent fluid channels on two opposite sides of the separator membranes.

According to other aspects of the method, a flow screen may be assembled between the separator membrane and each of the spaced outer sides of the anode plates and the cathode plates. Alternatively, a nickel foam member may be assembled between the separator membrane and each of the spaced outer sides of the cathode plates disposed in the catholyte fluid passage and the cathode plate assembly may be plated with a nickel plating.

Two conductors provided on the anode plate and two conductors provided on the cathode plate in the same location on the respective anode and cathode plates. Each anode plate is assembled to one of the cathode plates in an opposite orientation with the conductors spaced from each other. The conductors are attached to the anode plates with the conductors being aligned in an array. The conductors are attached to the cathode plates with the conductors being aligned in the same array with the conductors facing the adjacent plate but in spaced locations relative to the conductors on the anode plates.

### BRIEF DESCRIPTION OF THE DRAWINGS

FIG. 1 is a diagrammatic view of a modular stacked battery energy storage system;

FIG. 2 is an exploded perspective view of an anode plate, a cathode plate, a seal and two part housing for a modular stacked battery cell; and

FIG. 3 is a fragmentary diagrammatic cross-sectional view of several cells of a modular stacked battery system.

### DETAILED DESCRIPTION

A detailed description of the illustrated embodiments of the present invention are provided below. The disclosed embodiments are examples of the invention that may be embodied in various and alternative forms. The figures are not necessarily to scale. Some features may be exaggerated or minimized to show details of particular components. The specific structural and functional details disclosed in this application are not to be interpreted as limiting, but merely as a representative basis for teaching one skilled in the art how to practice the invention.

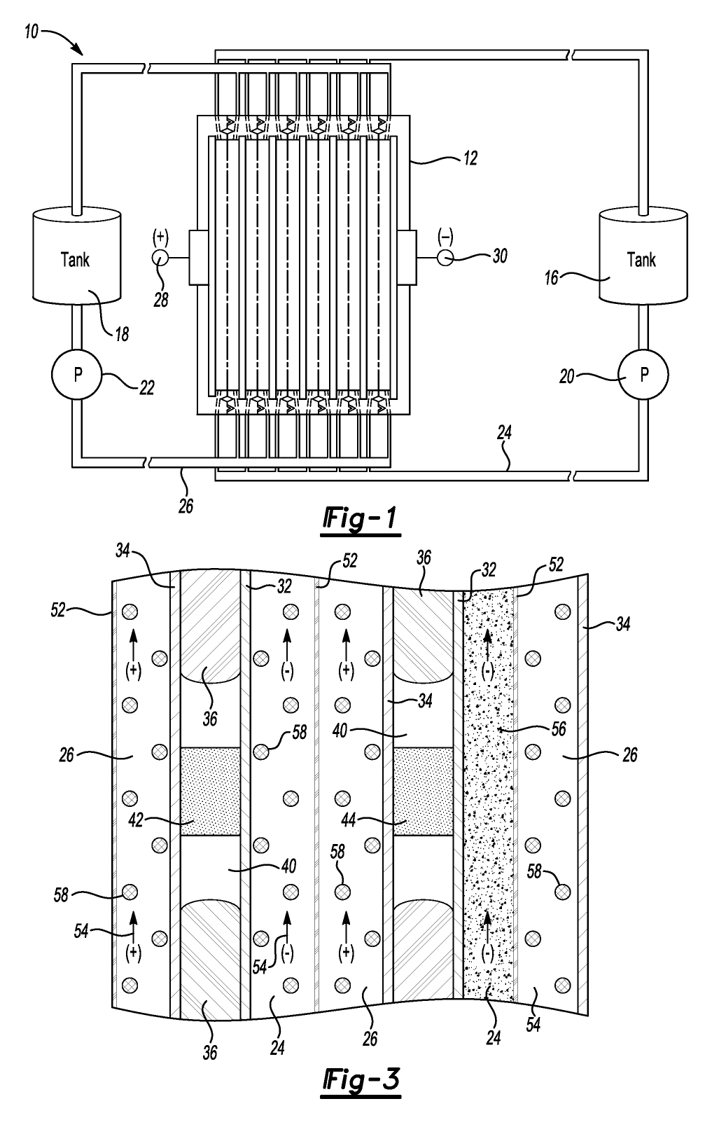

Referring to FIG. 1, a flow cell battery system 10 is shown that includes a modular stacked flow battery 12. An anolyte tank 16 and a catholyte tank 18 store and discharge energy through electrolytic fluids. An anolyte pump 20 and catholyte pump 22 circulate the electrolytic fluids through the battery 12. An anolyte fluid circuit 24 and catholyte fluid circuit 26 comprise piping or tubing that allow the electrolytic fluid to circulate and charge or discharge the system depending upon whether a load or charge is provided to the positive terminal 28 and negative terminal 30.

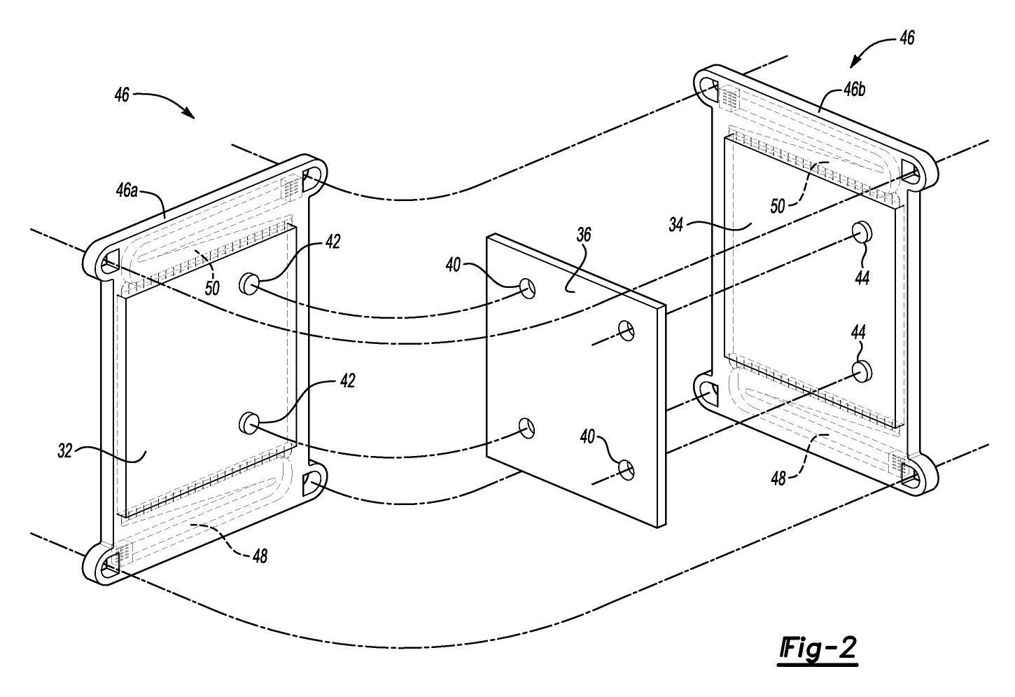

Referring to FIG. 2, an anode plate 32 and a cathode plate 34 are shown separately on opposite sides of a seal layer 36. The seal layer 36 has a plurality of openings 40. Hubs 42 are provided on the anode plate 32 and hubs 44 are provided on the cathode plate 34. A housing 46 is shown split into two halves 46a with one half 46a supporting the anode plate 32 and the other half 46b supporting the cathode plate 34. Inlet ports 48 and outlet ports 50 are formed at the two parts of the housing on the lower end and upper end of the housing 46.

Referring to FIG. 3, several modular cells are shown that include a cathode plate 32 and an anode plate 34 with a seal layer 36 that prevents the anolyte and catholyte from flowing between the anode plate 34 and cathode plate 32. The openings 40 in the seal layer 36 provide clearance for a set of hubs 42 provided on the anode plate 34 and hubs 44 provided on the cathode plate 32.

The anode plates 34 and cathode plates 32 are identical plates having different plating layers, such as cadmium plating and a nickel plating on the two plates, respectively. The pairs of anode and cathode plates 34 and 32 are arranged as paired assemblies with a membrane 52. The membrane 52 forms a barrier between an anolyte flow path 54 and a catholyte flow path 56. The membrane 52 prevents fluid flow between the two flow paths 54, 56, but permits transmission of electrons through the membrane for the purpose of charging and discharging the battery system. A flow screen 58 is provided in both the anolyte flow path 54 and the catholyte flow path 56. The flow screen 58 causes a mixing of the anolyte fluid and catholyte fluid as it flows upwardly from the inlet ports 48 to the outlet ports 50 that are formed in the housing 46. Instead of providing a flow screen 58, a nickel foam layer may be provided in catholyte flow path 56. The nickel foam layer facilitates the transmission of electrons between the catholyte flow path 56 and the anolyte flow path 54.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A module for an electrical charge storage apparatus that circulates an anolyte fluid and a catholyte fluid to charge and discharge the apparatus, the module comprising:
an anode plate assembly including a first anode plate and a first separator membrane defining the anolyte fluid passage on an outer side of the anode plate;
a cathode plate assembly including a first cathode plate and a second separator membrane defining a catholyte fluid passage on an outer side of the cathode plate,
at least one pole piece hub conductively connecting an inner side of the anode plate assembly to an inner side of the cathode plate assembly; and
a seal layer disposed between the anode plate and the cathode plate, the seal layer defines an opening for each pole piece hub, wherein the seal layer precludes the flow of the anolyte fluid and the catholyte fluid between the anode plate and the cathode plate around each pole piece hub.

2. The module of claim 1 further comprising a first flow screen disposed in the anolyte fluid passage and a second flow screen disposed in the catholyte fluid passage.

3. The module of claim 1 further comprising a nickel foam member disposed in the catholyte fluid passage, wherein the cathode plate assembly is plated with a nickel plating.

4. The module of claim 1 wherein the seal includes four openings, two pole piece hubs are provided on the anode plate and two pole piece hubs are provided on the cathode plate, wherein the anode plate and pole piece hubs that are provided on the anode hub are structurally identical to the cathode plate and two pole piece hubs are provided on the cathode plate, and wherein the anode plate and cathode plate are assembled to each other in an opposite orientation with the hubs spaced from each other.

5. The module of claim 1 further comprising a housing that receives the anode plate, the cathode plate and the seal, the housing defining anolyte inlet passages and anolyte outlet passages that are in fluid flow communication with the anolyte fluid passage, and the housing defining catholyte inlet passages and catholyte outlet passages that are in fluid flow communication with the catholyte fluid passage.

6. The module of claim 5 further comprising a peripheral seal provided between the housing, and the anode plate, the cathode plate and the seal that separates the anolyte from the catholyte.

7. An energy storage cell that is provided with an anolyte and a catholyte, the cell comprising:
a housing that defines a first set of flow passages for the anolyte and a second set of flow passages for the catholyte;
a plurality of anode plates having an inner surface and an outer surface;
a plurality of cathode plates having an inner surface and an outer surface;
a plurality of conductors assembled between the inner surface of the anode plates and the inner surface of the cathode plates to electrically connect one of the anode plates to one of the cathode plates to maintain each paired anode plate and cathode plate at the same electrical potential;
a plurality of separator membranes disposed between the outer surface of one of the anode plates and the outer surface of one of the cathode plates that defines an anolyte fluid passage and a catholyte fluid passage on opposite sides of each of the separator membranes; and
a seal layer provided between the inner surface of the anode plates and the inner surface of the cathode plates, the seal defining an opening for each of the conductors, wherein the seal layer prevents the anolyte and the catholyte from mixing between the inner surfaces of the anode plates and the inner surfaces of the cathode plates.

8. The energy storage cell of claim 7 further comprising a first flow screen disposed in the anolyte fluid passage and a second flow screen disposed in the catholyte fluid passage.

9. The energy storage cell of claim 7 further comprising a nickel foam member disposed in the catholyte fluid passage, wherein the cathode plate assembly is plated with a nickel plating.

10. The energy storage cell of claim 7 wherein the seal includes four openings, two conductors are provided on the anode plate and two conductors are provided on the cathode plate, wherein the anode plate and conductors that are provided on the anode hub are structurally identical to the cathode plate and two conductors are provided on the cathode plate, and wherein the anode plate and cathode plate are assembled to each other in an opposing orientation with the conductors spaced from each other.

11. The energy storage cell of claim 7 wherein the first set of flow passages is in fluid flow communication with the anolyte fluid passage, and the second set of fluid passages is in fluid flow communication with the catholyte fluid passage.

12. The energy storage cell of claim 11 further comprising a peripheral seal provided between the housing, and the anode plates, the cathode plates and the seals that separates the anolyte from the catholyte.

13. A method of making an energy storage cell comprising:
selecting a plurality of anode plates having an inner side and an outer side;
selecting a plurality of cathode plates having an inner side and an outer side;
attaching at least one conductor between each of the inner sides of the anode plates and cathode plates;
selecting a plurality of seal layers that each define at least one opening;
assembling each of the seals between the inner side of one of the anode plates and the inner side of one of the cathode plates with the conductors each being received within one of the openings in the seals;
assembling a separator membrane between each of the spaced outer sides of the anode plates and the cathode plates to define a plurality of adjacent fluid channels on two opposite sides of the separator membranes.

14. The method of claim 13 wherein the method further comprises:
assembling a flow screen between the separator membrane and each of the spaced outer sides of the anode plates and the cathode plates.

15. The method of claim 13 wherein the method further comprises:
assembling a nickel foam member between the separator membrane and each of the spaced outer sides of the cathode plates disposed in the catholyte fluid passage, wherein the cathode plate assembly is plated with a nickel plating.

16. The method of claim 13 comprising:
attaching two conductors on the anode plate and two conductors are provided on the cathode plate, wherein the anode plate and conductors that are provided on the anode hub are located in the same location on the respective anode and cathode plates; and
assembling anode plate to the cathode plate, and wherein the anode plates and cathode plate are assembled to each other in opposite orientations with the conductors spaced from each other.

17. The method of claim 16 wherein during the step of attaching the conductors to the anode plates the conductor are aligned in an array, and during the step of attaching the conductors to the cathode plates the are aligned in the same array with the conductors facing the adjacent plate but in spaced locations relative to the conductors on the anode plates.
